(19) United States
(12) Patent Application Publication
(10) Pub. No.: US 2008/0307900 A1
(43) Pub. Date: Dec. 18, 2008

(54) Self-contained wireless rotational speed sensing unit

(75) Inventors: David Abraham Paul, Peoria, IL (US); Seppo Saario, Brisbane (AU); Roger Dwight Watkins, Dunlap, IL (US); Balamurugan Sundaram, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/806,377

(22) Filed: May 31, 2007

(51) Int. Cl. G01P 3/44; G01L 3/02

(52) U.S. Cl. 73/862.193

(57) ABSTRACT

A speed sensing device for use with a traction device is disclosed. The speed sensing device has a rotor having a first rotational, wherein the rotor has magnets affixed thereon to generate a magnetic field. The speed sensing device also has a power-harvesting circuit coupled with the rotor to convert fluctuations in the magnetic field into electrical energy. The speed sensing device further has a sensor having a second rotational speed different from the first rotational speed, wherein the sensor is powered by the power-harvesting circuit to generate a signal indicative of a speed of the traction device. The speed sensing device still further has a transmitting circuit connected with the speed sensor and powered by the power-harvesting circuit to wirelessly transmit the generated signal.

### TECHNICAL FIELD

The present disclosure relates generally to a rotational speed sensing unit and, more particularly, to a self-contained wireless rotational speed sensing unit.

### BACKGROUND

The tracks and associated drivetrains of mobile machines such as, for example, dozers, excavators, and military tanks have many different moving parts that must cooperate precisely and efficiently in order to move the machines as requested by an operator. The moving parts can include, among other things, the crankshaft of an engine, a reduction gear train (i.e. transmission), a differential, one or more clutches, and final drive gear trains (e.g. one associated with each track). In order to efficiently control these devices to move the machine, it is beneficial to know certain operational parameters, such as the speed of the moving parts. Speed can be monitored by way of track speed sensors placed adjacent one or more of the moving parts listed above. However, because there are so many moving parts associated with each track, it is difficult or even impossible to run power and/or data wires to the sensor. Further, power and/or data wires connected to the sensor can be damaged by debris such as dirt, rocks, etc., that are kicked up by movement of the tracks, or by shock and vibration-induced movement incurred by the components and movement of the mobile machine. Thus, it is difficult or even impossible to reliably power the sensor using hard wires and/or receive speed signals generated by the sensor via hard wires.

One way to monitor the speed of the track-type traction devices without running power and/or data wires through the moving parts is to harness electrical power from the movement of one of the moving parts, and transmit data wirelessly to a remote receiving location. In this manner, the need for a power or data line to or from the sensor may be eliminated. One such wireless device is described in U.S. Pat. No. 6,892,587 (“the '587 patent”) issued to Mizutani et al. on May 17, 2005. Specifically, the '587 patent discloses a rotation detecting device including an electric power generator, a wireless transmission device, and annular sealing members to protect the electric power generator and wireless transmission device from dirt, grit, oil, grease, etc. The electric power generator includes an annular multi-pole magnetic assembly affixed to and about an inner rotatable member of a wheel bearing assembly via a first mounting. The multi-pole magnetic assembly serves as a rotor and has a series of alternating magnetic poles in a circumferential direction. The electric power generator also includes a magnetic ring assembly affixed to and within an outer non-rotatable member of the wheel bearing assembly via a second mounting. The ring assembly serves as a stator and has a coil encased therein. The multi-pole magnetic assembly and ring assembly are in a face-to-face relationship with a gap between the two such that the two rotate relative to each other. As they rotate, a magnetic flux about the ring assembly changes, thus generating electric power from the coil encased within the ring assembly. The generated power is then passed through the second mounting by a wire to power the wireless transmission device, which is of an annular type affixed to and within a non-rotatable (i.e. stationary) member of the wheel bearing assembly.

The speed of the wheel is indicated by detecting the frequency of pole changes of the magnetic field caused by the rotation of the multi-pole magnetic assembly. A signal indicative of this frequency is transmitted by the wireless transmission device. To minimize the infiltration of dirt, grit, oil, and grease, metal and/or rubber sealing members are also affixed annularly to protect the device. The components of the rotation detecting device are generally of an annular type and are affixed to the wheel bearing assembly and each other by way of at least one of vulcanization, interference fit, welding, and press-fitting.

While the rotation detecting device of the '587 patent may adequately power itself and wirelessly transmit a signal indicative of the rotational speed of a wheel, it may be limited in its effectiveness. Specifically, because speed of the wheel is sensed from a rotatable member that rotates at the same speed as the traction device (i.e. no gears or other mechanical advantages are used to rotate the rotatable member), its speed resolution may be limited. That is, the speed resolution of the sensor may be generally dependent on and limited by the number of pole changes observed by the ring assembly during one full rotation of the wheel. Speed resolution may be increased in two ways: by increasing the number of alternating magnetic poles of the multi-pole magnetic assembly, and/or by increasing the number of rotations of the multi-pole magnetic assembly per rotation of the wheel. For example, assume that the multi-pole magnetic assembly includes 11 pole changes per a single revolution of the multi-pole magnetic assembly, and that one revolution of the wheel corresponds to a traveled distance of 5 meters. The resolution of the speed detection signal is 1/11^{th} of a revolution of the multi-pole magnetic assembly. Because the multi-pole magnetic assembly rotates at the same speed as the wheel, the resolution of the speed detection signal is equivalent to 1/11^{th} of a revolution of the wheel (i.e. 5/11^{th} of a meter). If the same multi-pole magnetic ring assembly could be affixed to a component of the wheel assembly that rotated faster than the wheel, then the speed resolution could be increased. Thus, because the multi-pole magnetic ring assembly of the '587 patent may rotate only at the same speed as the wheel, the resolution of the rotation detecting device of the '587 patent may be limited by the size and manufacturing requirements of the multi-pole magnetic assembly.

Also, the rotation detecting device may be difficult and/or expensive to manufacture, assemble, and repair. More specifically, because the rotation detecting device of the '587 patent includes a number of separately manufactured annular parts with shapes particular to the components of the wheel bearing assembly upon which they are to be fitted, the manufacture of these parts may be difficult and/or expensive. Similarly, assembly and disassembly for repair purposes of the rotation detecting device may be difficult and/or expensive. Also, because the annular shapes of the components of the rotation detecting device are dependent on the shape of the wheel bearing assembly on which they are to be mounted, two different wheel bearing assemblies may require that substantially different rotation detecting devices be manufactured, thus further increasing the manufacturing cost.

Further, because the rotation detecting device of the '587 patent must have an annular rotor and an annular stator, its application may be limited. That is, the rotation detecting device may be limited to wheel bearing assemblies that provide a rotating member and a non-rotating member that are sufficiently positioned such that the rotor and the stator of the rotation detecting device may be mounted thereon in a face-to-face relation.

The rotational speed sensor unit of the present disclosure solves one or more of the problems set forth above.

### SUMMARY OF THE INVENTION

One aspect of the present disclosure is directed to a speed sensing device for use with a traction device. The speed sensing device includes a rotor having a first rotational speed, wherein the rotor includes magnets affixed thereon to generate a magnetic field. The speed sensing device also includes a power-harvesting circuit coupled with the rotor to convert fluctuations in the magnetic field into electrical energy. The speed sensing device further includes a sensor having a second rotational speed different from the first rotational speed, wherein the sensor is powered by the power-harvesting circuit to generate a signal indicative of a speed of the traction device. The speed sensing device still further includes a transmitting circuit connected with the speed sensor and powered by the power-harvesting circuit to wirelessly transmit the generated signal.

Another aspect of the present disclosure is directed to a method of sensing a ground speed. The method includes rotating a traction device at a first speed, and rotating a rotor at a second speed different from the first speed to generate a magnetic field. The method also includes converting fluctuations in the magnetic field into electrical power. The method further includes generating a signal indicative of the first speed, and transmitting the generated signal.

### BRIEF DESCRIPTION OF THE DRAWINGS

FIG. 1 is a diagrammatic illustration of an exemplary disclosed machine;

FIG. 2 is a diagrammatic illustration of an exemplary disclosed final drive and speed sensing device for use with the machine of FIG. 1; and

FIG. 3 is a schematic and block diagram of an exemplary disclosed operational circuitry for use with the speed sensing device of FIG. 2.

### DETAILED DESCRIPTION

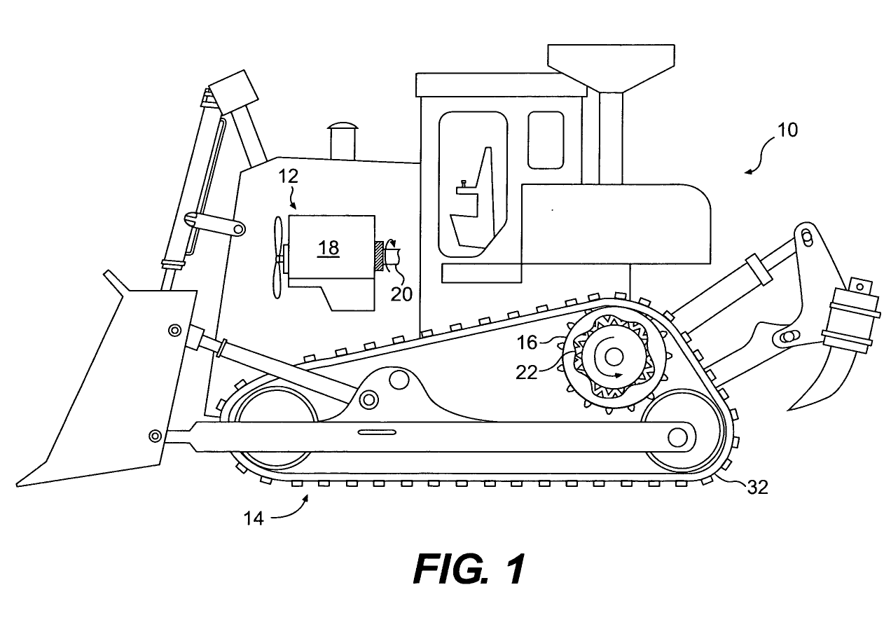

FIG. 1 illustrates a mobile machine 10 having a power source 12 and a traction device 14 driven by power source 12. Mobile machine 10 may be a mobile machine that performs some type of operation associated with an industry such as mining, construction, farming, or any other industry known in the art. For example, mobile machine 10 may be an earth moving machine such as a dozer, a loader, an excavator, or any other earth moving machine. Power source 12 may be a combustion engine such as, for example, a diesel engine, a gasoline engine, a gaseous fuel-powered engine, or any other engine suitable for driving a tracked undercarriage of machine 10. Power source 12 may also be a non-combustion source of power such as, for example, a fuel cell, a power storage device, or any other source of power known in the art.

Power source 12 may deliver torque to traction device 14 by way of opposing sprockets 16 (only one shown in FIG. 1). More specifically, power source 12 may include an engine block 18, and a crankshaft 20 rotatably disposed within engine block 18. Crankshaft 20 of power source 12 may be drivably connected to opposing sprockets 16 via a drivetrain. Although not shown, the drivetrain may include a number of moving parts interconnected to transfer mechanical power from crankshaft 20 to opposing sprockets 16, such as, for example, a differential, opposing clutches, and opposing final drives 22 (only one shown in FIG. 1).

Traction device 14 may include two separate continuous tracks 32, located on each side of mobile machine 10 (only one shown in FIG. 1). Alternatively, traction device 14 may include belts, wheels, or other driven traction devices. It is contemplated that traction device 14 may or may not be steerable. Traction device 14 may engage a ground surface, and may be driven (i.e. by the rotation of opposing sprockets 16) to propel mobile machine 10 along the ground surface.

In an exemplary operation of traction device 14, a rotation of crankshaft 20 may drive the rotation of opposing sprockets 16, as described above. The rotation of opposing sprockets 16 may thus deliver a torque to traction device 14, causing traction device 14 to rotate and propel mobile machine 10. It is contemplated that an amount of mechanical power produced by power source 12 may correspond to a rotational speed and an amount of torque delivered by opposing sprockets 16.

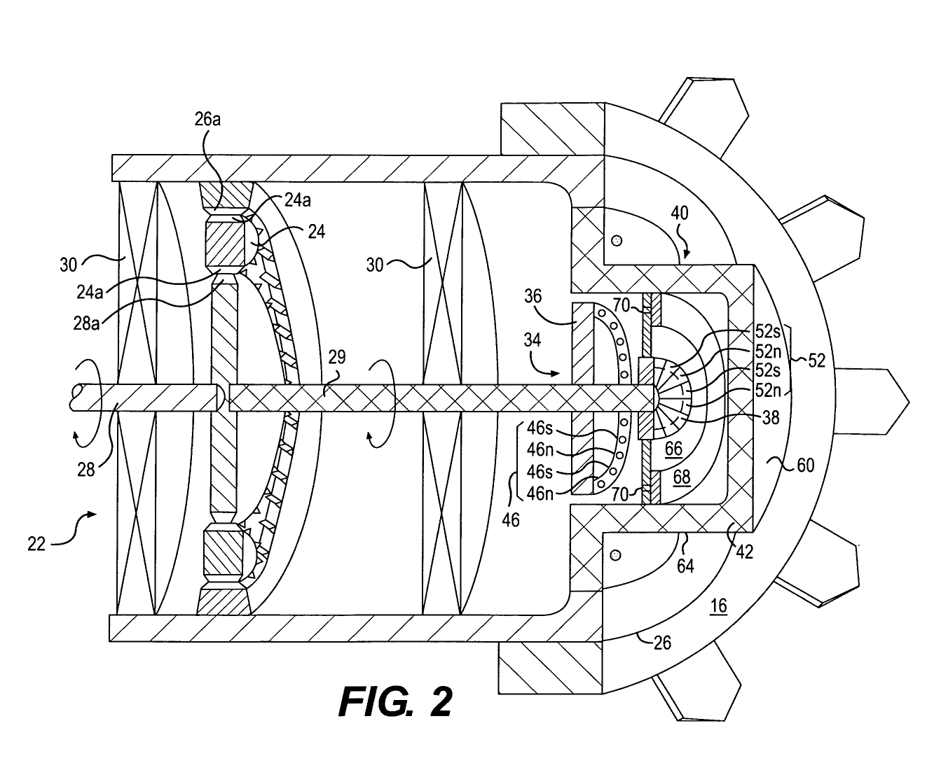

In some applications, it may be desirable to determine a speed of traction device 14. In order to sense the speed of traction device 14, mobile machine 10 may include one or more rotational speed sensing devices 34 (shown in FIG. 2) associated with final drive 22 or another rotating component. Rotational speed sensing devices 34 may utilize wireless communications. It should be appreciated that the speed of traction device 14 may include a direction component and a velocity component. In a preferred embodiment, mobile machine 10 may include two wireless rotational speed sensing devices 34, each configured to sense a speed of a respective one of the two continuous tracks 32.

As illustrated in FIG. 2, final drive 22 may include a gear train 24 within a final drive housing 26. Gear train 24 may be connected to a rotatable shaft 28 to receive mechanical power therefrom, and to sprocket 16 by way of final drive housing 26 to deliver mechanical power thereto. For example, gear train 24 may be connected to rotatable shaft 28 and sprocket 16 by interlocked protrusions (e.g. teeth). More specifically, rotatable shaft 28 may include teeth 28a operable to engage teeth 24a of gear train 24 (i.e. of two or more planet gears of gear train 24), and connected to receive the mechanical power transferred from crankshaft 20. Thus, the rotation of rotatable shaft 28 may drive gear train 24 to rotate. The teeth of gear train 24 may also engage set of inner teeth 26a of final drive housing 26 such that a rotation of gear train 24 may drive final drive housing 26 and connected sprocket 16 to rotate. It should be noted that gear train 24 may include a plurality of gears (not shown) sized to transfer the mechanical power received from rotatable shaft 28 to sprocket 16 such that sprocket 16 rotates at a speed less than the speed of rotatable shaft 28.

Gear train 24 also may be connected to drive a rotatable member 29 extending from gear train 24 in opposition to rotatable shaft 28. That is, rotatable member 29 may embody a shaft that rotates at substantially the same speed as rotatable shaft 28. As such, the rotational speed of rotatable member 29 may be related to the rotational speed of sprocket 16 by a known conversion factor (“gear ratio”). For example, twenty-two revolutions of rotatable member 29 may correspond to one revolution of sprocket 16. Rotatable member 29 may be configured to displace axially and/or radially to offset shock and vibration-induced movement incurred by the components and movement of mobile machine 10. For example, rotatable member 29 may be connected to gear train 24 via one or more sliding or misalignment joints such that an axial and/or radial movement of gear train 24 may not transfer to rotatable member 29. More specifically, rotatable member 29 may be connected to gear train 24 via a spline, a key, or any other type of axial sliding connection known in the art. Alternatively or additionally, rotatable member 29 may be connected to gear train 24 via a universal joint, a sliding disk joint, or any other type of angular (i.e. radial) misalignment connection known in the art. Although shown extending from a center of gear train 24 (i.e. in alignment with rotatable shaft 28), it should be appreciated that rotatable member 29 may be attached to any of the gears of gear train 24 or any other member of the drivetrain of mobile machine 10, as long as the rotational gear ratio of rotatable member 29 to the rotation of sprocket 16 can be determined. As such, it should also be appreciated that rotatable member 29 may rotate at any other speed that is greater than the speed of sprocket 16.

Final drive housing 26 may generally protect the components of final drive 22 from the elements. For example, final drive housing 26 may generally be affixed to an outer surface of sprocket 16 such that final drive housing 26 rotates in substantial unity with sprocket 16. More specifically, final drive housing 26 may include a plurality of fixed bearings 30 positioned between final drive housing and at least one of rotatable shaft 28 and rotatable member 29. As sprocket 16 is driven to rotate, final drive housing 26 may rotate with sprocket 16 by running over fixed bearings 30.

Rotational speed sensing device 34 may generally include a rotor 36 affixed to rotatable member 29, a magnetic ring 38 also affixed to rotatable member 29, and a speed sensing unit 40 contained within a housing 42. Rotor 36 may be attached to rotatable shaft 28 to rotate at a speed substantially equal to the rotational speed of rotatable shaft 28. It should be appreciated that rotor 36 may be rigidly attached to rotatable shaft 28, or attached via an axial and/or radial misalignment compensating coupling, as is known in the art. Rotor 36 may have a substantially disklike shape, and may include, affixed thereon, a series of magnets 46. Magnets 46 may embody any type of magnets such as, for example, rare earth neodymium-iron-boron magnets. Further, magnets 46 may be affixed to rotor 36 by any means known in the art. For example, magnets 46 may be embedded and/or bonded to rotor 36. Magnets 46 may extend axially from rotor 36, and may be evenly spaced in a circumferential direction. Further, adjacent magnets 46 may be of alternating polarities. More specifically, magnets 46 may include an equal number of N-polarized magnets 46n and S-polarized magnets 46s in an alternating arrangement. It is contemplated that rotor 36 may include any number of magnets 46, as long as adjacent magnets are of alternating polarities. In one exemplary embodiment, rotor 36 may include thirty-six magnets (i.e. eighteen N-polarized magnets 46n and eighteen S-polarized magnets 46s). It is further contemplated that each magnet 46 may embody a series of magnets 46 of the same polarity, such that sets of N-polarized magnets 46n are placed adjacent sets of S-polarized magnets 46s. For example, magnets 46 may be arranged in circumferential direction such that three N-polarized magnets 46n are followed by three S-polarized magnets 46s, which are followed by three N-polarized magnets 46n, and so on. It is also contemplated that rotor 36 may alternatively embody a magnetically encoded ring of alternating equally-sized poles, if desired.

Magnets 46 may generate a first magnetic field. If rotor 36 is held stationary, the first magnetic field may be substantially static, as observed from a stationary reference point. As rotor 36 rotates, however, a movement of magnets 46 relative to the stationary reference point may cause the first magnetic field at the stationary reference point to experience a first magnetic flux. It should be appreciated that the first magnetic flux may be time-varying. More specifically, because magnets 46 may be arranged with alternating polarities, a polarity of the first magnetic field may alternate at a frequency related to the number of magnets 46 and the rotational speed of rotor 36. One skilled in the art should appreciate that the first magnetic flux may also be observed at a reference point in rotational motion concurrent with the rotation of rotor 36. More specifically, a reference point rotating about the same axis as rotor 36, but at a different speed than rotor 36, may also observe the first magnetic flux caused by the motion of magnets 46, with a frequency related to the number of magnets 46 and the difference in rotational rates of rotor 36 and the rotating reference point. For example, a fixed reference point on final drive housing 26 may rotate one revolution for every twenty-two revolutions of each magnet 46, and may observe the first magnetic flux caused by the revolutions of magnets 46.

Magnetic ring 38 may also be attached to rotatable shaft 28 to rotate at a speed substantially equal to the rotational speed of rotor 36. It should be appreciated that magnetic ring 38 may be rigidly attached to rotatable shaft 28, or attached via an axial and/or radial misalignment compensating coupling, as is known in the art. As shown in FIG. 2, magnetic ring 38 may also have a substantially disklike shape, and may embody a magnetically encoded ring of alternating equally-sized poles 52. Poles 52 may be evenly spaced in a circumferential direction. Further, poles 52 may be of alternating polarities. More specifically, poles 52 may include an equal number of N-polarized poles 52n and S-polarized poles 52s in an alternating arrangement. It is contemplated that magnetic ring 38 may include any number of poles 52, as long as adjacent poles are of alternating polarities. It is further contemplated that magnetic ring 38 may alternatively embody a rotor with affixed magnets of alternating polarities, similar to rotor 36.

Poles 52 may generate a second magnetic field. If magnetic ring 38 is held stationary, the second magnetic field may be substantially static, as observed from a stationary reference point. As magnetic ring 38 rotates, however, a movement of poles 52 relative to the stationary reference point may cause the second magnetic field at the stationary reference point to experience a second magnetic flux. It should be appreciated that the second magnetic flux may be time-varying. More specifically, because poles 52 may be arranged with alternating polarities, a polarity of the second magnetic field may alternate at a frequency related to the number of poles 52 and the rotational speed of magnetic ring 38. One skilled in the art should appreciate that the second magnetic flux may also be observed at a reference point in rotational motion concurrent with the rotation of magnetic ring 38. More specifically, a reference point rotating about the same axis as magnetic ring 38, but at a different speed than magnetic ring 38, may also observe the second magnetic flux caused by the motion of poles 52, with a frequency related to the number of poles 52 and the difference in rotational rates of rotor 36 and the rotating reference point. For example, a fixed reference point on final drive housing may rotate one revolution for every twenty-two revolutions of each pole 52, and may observe the second magnetic flux caused by the revolutions of poles 52.

Speed sensing unit 40 may generally include a printed circuit board (“PCB”) 66 contained within housing 42 and having functional circuitry installed thereon. It should be appreciated that the functional circuitry of PCB 66 may be installed on PCB 66 in any manner known in the art. For example, the functional circuitry may include off-the-shelf components soldered on to PCB 66. Alternatively, the functional circuitry may be printed on PCB 66. Housing 42 may embody a machined metal casting made to attach to final drive housing 26, and may have a dielectric outer shell 60 to protect the functional circuitry of PCB 66 from the elements and other contaminants such as, for example, dirt grit, oil, grease, etc. More specifically, housing 42 may have a generally disklike shape with an annular protrusion 64 extending axially therefrom to form a cylinder about PCB 66. Housing 42 may be positioned such that magnetic ring 38 extends axially into a central portion of the cylinder defined by annular protrusion 64. Housing 42 may further include a series of screw or bolt-receiving holes arranged circumferentially so that housing 42 may be secured to final drive housing 26. More specifically, housing 42 may be screwed or bolted onto an outer surface of final drive housing 26 such that annular protrusion 64 extends away from mobile machine 10, and housing 42 is axially aligned with the center of sprocket 16. It is contemplated that housing 42 may alternatively be affixed directly onto sprocket 16, if desired.

Because housing 42 may be secured to final drive housing 26, housing 42 and the components of self-contained speed sensing unit 40 may be caused to rotate in substantial unity with sprocket 16. As such, the rotation of rotor 36 and magnetic ring 38 may be related to the rotation of self-contained speed sensing unit 40 by the known gear ratio. For example, twenty-two revolutions of rotor 36 and magnetic ring 38 may correspond to one revolution of self-contained speed sensing unit 40.

PCB 66 may be affixed to an inner portion of housing 42, and may have a generally disklike shape with a substantially circular opening wide enough to fit around magnetic ring 38. PCB 66 may also have an inner annular face, and an outer annular face. PCB 66 may be bolted to the inner portion of housing 42 such that when housing 42 is mounted on final drive 22, rotor 36 is in a face-to-face relationship with, and in close proximity to, the inner annular face of PCB 66. In one exemplary embodiment, rotor 36 may be within 1.5 mm of the inner annular face. At this proximity to rotor 36 (and thus, magnets 46), components installed on the inner annular face of PCB 66 may experience the first magnetic flux caused by the rotation of magnets 46 relative to PCB 66. The outer annular face of PCB 66 may include a ferrous metal ring 68 used to reduce a path reluctance of the first magnetic flux, thus concentrating the first magnetic flux along ferrous metal ring 68. It is contemplated that PCB 66 may alternatively embody a plurality of printed circuit boards configured to rotate in substantial unity with housing 42, if desired.

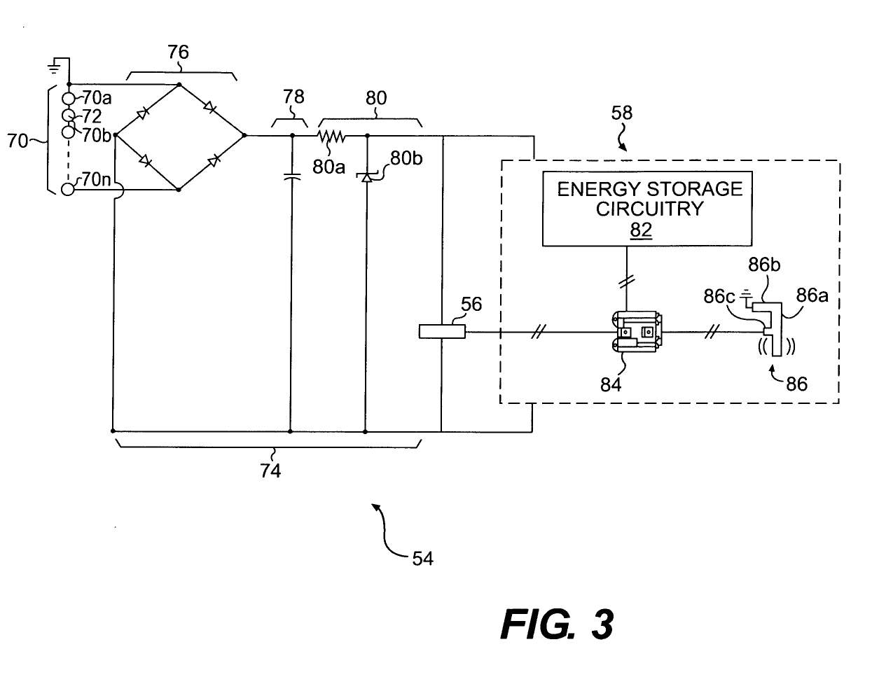

Referring to FIG. 3, the functional circuitry of PCB 66 may include a power-harvesting circuit 54, a sensor 56, and a wireless transmitting circuit 58. It is contemplated that the functional circuitry of PCB 66 may be installed on the inner and/or outer annular faces of PBC 66, as desired. It is also contemplated that the functional circuitry of PCB 66 may additionally include any number of other electrical circuits and/or sensors, if desired.

Power-harvesting circuit 54 may generally include a ring of inductors 70 having axial magnetic cores 72, and a power regulation circuit 74. More specifically, inductors 70 (and respective axial magnetic cores 72) may extend axially from the inner annular face of PCB 66 toward rotor 36. Thus, a first end of each magnetic core 72 may face rotor 36 while an opposing second end of each magnetic core 72 may face ferrous metal ring 68. Inductors 70 may be positioned similar to magnets 46 of rotor 36. That is, inductors 70 may be evenly spaced in a circumferential direction, and inductors 70 may be placed at a radial distance equal to a radial distance of magnets 46. It should be noted, however, that unlike magnets 46 of rotor 36, magnetic cores 72 may not be polarized. That is, magnetic cores 72 may embody inert ferrite cores having substantially no magnetic polarity operable to enhance a magnitude of a magnetic field about inductors 70, as is known in the art. It is contemplated that power-harvesting circuit 54 may include any number of inductors 70. In one exemplary embodiment, power-harvesting circuit 54 may include thirty inductors 70. It should be appreciated that the number of inductors 70 may be chosen to differ from the number of magnets 46 such that torque and axial force pulses created by their interaction may be minimized so as not to interfere with the operation of rotational speed sensing device 34.

Inductors 70 may be connected to additively induce an AC voltage signal. For example, a first one of the inductors 70 (i.e. inductor 70a) may be connected to ground on a first side, and to an adjacent one of the inductors 70 (i.e. inductor 70b) on an opposing second side. The rest of the inductors 70 may similarly be connected in series to their adjacent inductors, with the exception of inductor 70n. In particular, rather than connecting in series back to the first side of inductor 70a (i.e. ground), inductor 70n may be connected to power regulation circuit 74. Thus, as a magnetic field fluctuates in the vicinity of inductors 70, a voltage may be induced in each inductor 70, and because they may be serially connected, an AC voltage with a voltage equal to a sum of the individual induced voltages may be passed to power regulation circuit 74. It should be appreciated that a period of the AC voltage may be substantially equal to the amount of time it takes for the magnetic field to change polarity twice. That is, the AC voltage may have a waveform with positive and negative voltages, the positive voltages corresponding to one of the two polarities of the first magnetic field (i.e. N-polarity and S-polarity), and the negative voltages corresponding to the other of the two polarities. Thus, as rotor 36 rotates and magnets 46 pass inductors 70 with alternating polarities, inductors 70 may generate the AC voltage with corresponding positive and negative voltages. It should also be appreciated that a strength of the magnetic field, and thus the amounts of induced voltages, may be enhanced by the presence of ferrous metal ring 68.

Power regulation circuit 74 may generally serve to rectify, filter, and regulate the AC voltage produced by inductors 70 to output a substantially steady DC voltage. For example, power regulation circuit 74 may include a rectifier 76 such as, for example, a full-wave rectifier to convert the AC voltage to DC voltage. More specifically, rectifier 76 may convert negative polarity voltages of the AC voltage to positive polarity voltages of the same amplitude. Although shown as including only one rectifier 76, it should be appreciated that rectifier 76 may alternatively embody a plurality of rectifiers 76, each connected to receive voltage from one or more respective inductors 70. Power regulation circuit 74 may also include a filter 78 such as, for example, a filter capacitor connected across the output of rectifier 76 to filter (i.e. smooth) the DC output of rectifier 76. Further, power regulation circuit 74 may include a regulator 80 such as, for example, a zener diode regulator having a resistor 80a connected along a positive voltage output line of filter, and a zener diode 80b connected across an output of resistor 80a and a low voltage (i.e. ground) output of rectifier 76 to provide a DC output of a desired steady voltage and/or current. It is contemplated that power regulation circuit 74 may include any number of other components such as, for example, a temperature sensor to detect whether the components of power regulation circuit 74 are within a rated temperature range, if desired.

It should be appreciated that the filter capacitor, resistor 80a, and zener diode 80b may be chosen based on operational parameters appropriate to yield a desired DC voltage, current and/or power, as is known in the art. For example, the filter capacitor, resistor 80a, and zener diode 80b may be chosen to produce a steady output of 7.5V. It should also be appreciated that power regulation circuit 74 may alternatively rectify, filter, and regulate the AC output produced by inductors 70 in any other manner known in the art. In one alternative example, rectifier 76 may embody a switching circuit designed to switch current to flow through a power resistor if the amount of power (e.g. voltage multiplied by current) produced by inductors 70 exceeds a desired amount. It should further be appreciated that power regulation circuit 74 may be installed on the inner annular face of PCB 66, outer annular face of PCB 66, or a combination thereof.

The DC output produced by power regulation circuit 74 may be supplied to power both sensor 56 and wireless transmitting circuit 58. Sensor 56 may be installed on the inner annular face or outer annular face of PCB 66 to generate a signal indicative of a speed of traction device 14, as indicated by fluctuations in the second magnetic field generated by the rotation of magnetic ring 38. For example, sensor 56 may embody a Hall Effect sensor installed on the outer annular face of PCB 66 such that sensor 56 faces an outer circumference of magnetic ring 38. Thus, sensor 56 may detect a pole change in the second magnetic field and output an electrical signal to indicate this pole change. More specifically, each time the magnetic field about sensor 56 changes polarity, sensor 56 may toggle its output between a low DC output (e.g. 0 volts) and a high DC output (e.g. 3 volts). Thus, the signal generated by sensor 56 may embody a periodic waveform with a period equal to an amount of time elapsed during two polarity changes of the magnetic field. It is contemplated that sensor 56 may alternatively be placed adjacent an inner or outer face of magnetic ring 38, if desired.

Sensor 56 may be communicatively coupled with wireless transmitting circuit 58, which may generally use the signal generated by sensor 56 to calculate and transmit a signal indicative of the speed of traction device 14 to the receiving system of mobile machine 10. Wireless transmitting circuit 58 may include, for example, energy storage circuitry 82, a controller 84, and a radio antenna 86, each of which may be installed on PCB 66 to receive the DC output from power-harvesting circuit 54. It is contemplated that wireless transmitting circuit 58 may further include other components, if desired. In one example, wireless transmitting circuit 58 may further include power regulation circuitry to further regulate the DC output of power-harvesting circuit 54 to a desired voltage level for one or more components of wireless transmitting circuit 58. In another example, wireless transmitting circuit 58 may further include a temperature sensor to detect whether the components of wireless transmitting circuit 58 are within a rated temperature range.

Energy storage circuitry 82 may be connected to store excess energy delivered from power-harvesting circuit 54 to wireless transmitting circuit 58. That is, as power-harvesting circuit 54 delivers its DC output to power wireless transmitting circuit 58, it may deliver more power than required to power controller 84 and radio antenna 86. When this happens, the excess power may be stored by energy storage circuitry 82 as a backup power source for controller 84 and radio antenna 86. Thus, energy storage circuitry 82 may allow for continuous transmission of speed data by providing power to controller 84 and radio antenna 86 when the power delivered by power-harvesting circuit 54 temporarily falls below an acceptable threshold for powering controller 84 and radio antenna 86. As such, energy storage circuitry may embody any rechargeable energy source such as, for example, one or more electro-chemical cells, batteries, capacitors, or super-capacitors, and may be connected to capture the excess energy as is known in the art. It is contemplated that energy storage circuitry may further include other components such as, for example, a switch operable to toggle the power source of controller 84 and/or radio antenna 86 between the DC voltage output of power-harvesting circuit 54 and the power stored by energy storage circuitry 82.

Controller 84 may generally process the signal generated by sensor 56 and deliver the processed signal to radio antenna 86 for transmission. As such, controller 84 may be communicatively coupled with sensor 56 and radio antenna 86, and may embody a single microprocessor or multiple microprocessors that include a means for processing the signal generated by sensor 56. For example, controller 84 may include a memory, a counter, a secondary storage device, and a processor, such as a central processing unit or any other means for processing the signal generated by sensor 56. Numerous commercially available microprocessors, microcontrollers, digital signal processors (DSPs), and other similar devices including field programmable gate arrays (FPGAs) programmed to act as a processor can be configured to perform the functions of controller 84. It should be appreciated that controller 84 may include one or more of an application-specific integrated circuit (ASIC), an FPGA, a computer system, and a logic circuit, configured to allow controller 84 to function in accordance with the present disclosure. Thus, the memory of controller 84 may embody, for example, the flash memory of an ASIC, flip-flops in an FPGA, the random access memory of a computer system, or a memory circuit contained in a logic circuit. Controller 84 may be further communicatively coupled with an external computer system, instead of or in addition to including a computer system.

Controller 84 may process the signal generated by sensor 56 to generate a new signal indicative of the speed of traction device 14. For example, controller 84 may include, stored in its memory, an algorithm to generate a signal indicative of the ground speed of traction device 14 based on the signal generated by sensor 56. As discussed above, the signal generated by sensor 56 may embody a waveform that alternates between 0V and 3V with a period equal to the amount of time it takes for two poles of magnetic ring 38 to pass sensor 56. The counter of controller 84 may increment at a known frequency such as, for example, 1,000 MHz. Each time controller 84 detects a rising edge of the waveform, it may read the value of the counter and reset the counter to zero. Thus, the read value of the fixed-frequency counter may substantially equal the number of microseconds since the last rising edge of the waveform was detected. Controller 84 may compare the number of microseconds since the last rising edge of the waveform to the number of magnetic poles arranged circumferentially about magnetic ring 38, the known gear ratio, and a known conversion between the rotation speed of sprocket 16 and the speed of traction device 14 to calculate the speed of traction device 14. That is, the memory of controller 84 may have stored therein a number of known values that may be used in the calculation of the speed of traction device 14, such as, for example, the number of magnetic poles arranged circumferentially about magnetic ring 38, the known gear ratio, the known conversion, and a length of traction device 14. Controller 84 may also have stored in its memory a formula that utilizes the value of the counter, the signal generated by sensor 84, and the known values stored in the memory of controller 84 to calculate the speed of traction device 14. Alternatively or additionally, when the rotor 36 is driven to rotate at higher speeds, the algorithm may perform a counting function to count the number of magnetic field changes detected by sensor 56 in a specified period of time. It should be appreciated that in this manner, the algorithm may utilize the frequency and/or period of the signal generated by sensor 56 to calculate the ground speed of traction device 14 at any speed of traction device 14. Controller 84 may output the calculated speed to radio antenna 86 for wireless transmission. It should be appreciated that the signal generated by sensor 56 may alternatively be delivered to radio antenna 86 for wireless transmission to the receiving system of mobile machine 10, which may calculate the ground speed of traction device 14 based on the signal generated by sensor 56.

It is also contemplated that controller 84 may additionally deliver other information to radio antenna 86 for wireless transmission, if desired. In one example, controller 84 may be communicatively coupled with energy storage circuitry 82 to determine whether wireless transmitting circuit 58 is being powered by power-harvesting circuit 54 or energy storage circuitry 82, and deliver this information to radio antenna 86 for wireless transmission. If controller 84 determines that wireless transmitting circuit 58 is being powered by energy storage circuitry 82, it may also determine the remaining power held by energy storage circuitry 82 and/or how much longer energy storage circuitry 82 may power wireless transmitting circuit 58 before its stored power is depleted, and deliver this information to radio antenna 86 for wireless transmission. In another example, controller 84 may be communicatively coupled with the temperature sensor of power-harvesting circuit 54 and/or the temperature sensor of wireless transmitting circuit 58 to determine the temperatures of power-harvesting circuit 54 or wireless transmitting circuit 58, respectively, and deliver this information to radio antenna 86 for wireless transmission.

Radio antenna 86 may generally transmit the information received from controller 84 to the receiving system of mobile machine 10. Radio antenna 86 may be operable to transmit information over any proprietary or non-proprietary wireless transmission protocol such as, for example, EmberNet, Bluetooth, cellular protocols, IEEE 802.x, etc., that is fast enough to transmit each speed signal received from controller 84. For example, radio antenna 86 may be mounted on a ground plane, and may be connected to controller 84 via an interconnecting signal cable. Radio antenna 86 may further be mounted in close proximity to dielectric outer shell 60 to allow radio frequency energy to pass through dielectric outer shell 60, as is known in the art. As illustrated in FIG. 3, radio antenna 86 may have an inverted F shape with a main antenna member 86a, a first axial member 86b connected to ground, and a second axial member 86c connected to receive the information from controller 84.

Although the above-described embodiment of the present disclosure may represent one example, it is contemplated that other embodiments may exist. For example, in a first alternative embodiment, magnetic ring 38 may be omitted entirely and sensor 56 may instead generate signals based on the first magnetic field generated by magnets 46 of rotor 36. More specifically, sensor 56 may be installed on the inner annular face of PCB 66 in a face-to-face relationship with magnets 46 such that sensor 56 may detect a pole change in the first magnetic field and output an electrical signal to indicate this pole change. More specifically, each time the magnetic field about sensor 56 changes polarity, sensor 56 may toggle its output between a low DC output (e.g. 0 volts) and a high DC output (e.g. 3 volts). Thus, the signal generated by sensor 56 may embody a periodic waveform with a period equal to an amount of time elapsed during two polarity changes of the magnetic field, and the formula of controller 84 may use this periodic waveform along with the number of magnets 46 included in rotor 36 to calculate the speed of traction device 14.

In a second alternative embodiment, magnetic ring 38 may be omitted entirely and sensor 56 may embody a virtual sensor. More specifically, because the AC voltage signal generated by inductors 70 of power-harvesting circuit 54 may have a waveform with positive and negative voltages, the positive voltages corresponding to one of the two polarities of the first magnetic field, a period of the AC voltage signal may be used as the period of signal generated by sensor 56 to calculate the speed of traction device. That is, each time controller 84 detects a change to positive voltage in the AC voltage signal, it may read the value of the fixed-frequency counter and reset the fixed-frequency counter to zero. The remaining calculation of the speed of traction device 14 may be substantially the same as the above-described calculation, and thus is not repeated here for the sake of brevity.

### INDUSTRIAL APPLICABILITY

The disclosed method and apparatus may be applicable to detecting a speed of a traction device of a machine without a need for power lines or data lines wired through moving parts of the machine. Although described herein with reference to a track-type mobile machine, it is contemplated that the disclosed method and apparatus may, in fact, be applicable to any mobile machine with a suitable final drive. The disclosed apparatus may be powered by converting mechanical energy of a moving part to electrical energy. The disclosed apparatus may further sense the speed of the traction device and transmit the sensed speed wirelessly to a receiving system onboard or offboard the machine. An exemplary disclosed operation of wireless rotational speed sensing device 34, with reference to mobile machine 10, is provided below.

Referring to FIG. 1, power source 12 may receive and combust a mixture of fuel and air to produce a mechanical power output in the form of a rotation of crankshaft 20. The rotation of crankshaft 20 may be transferred to rotatable shaft 28, as described above, causing rotation of rotor 36 and magnetic ring 38 in substantial unity. Rotatable shaft 28 may also drive gear train 24 such that rotatable member 29 rotates, and sprocket 16 rotates together with final drive housing 26 and speed sensing unit 40 in substantial unity. The rotation of sprocket 16 may thus deliver a torque to traction device 14, causing traction device 14 to rotate and propel mobile machine 10. As discussed above, the known gear ratio may relate the rotation of speed sensing unit 40 to the rotation of both rotor 36 and magnetic ring 38, as shown in FIG. 2. For example, a single revolution of speed sensing unit 40 may correspond to twenty-two revolutions of rotor 36 and magnetic ring 38. In other words, rotor 36 and magnetic ring 38 may be caused to rotate relative to speed sensing unit 40, and each may rotate proportionally to the speed of traction device 14.

Referring now to FIG. 3, as rotor 36 rotates, the first magnetic field created by magnets 46 may fluctuate as observed from each of inductors 70, thus inducing a voltage across each of inductors 70. That is, as magnets 46 of alternating polarities rotate past a respective one of inductors 70, the magnetic field at that inductor may correspondingly alternate polarities, which may induce an AC waveform in the inductor with polarity periodically alternating from a positive voltage to a negative voltage, accordingly. The voltage amplitude of this alternating periodic waveform may be enhanced by the presence of both ferrous metal ring 68 and core magnets 46, as is known in the art. Because inductors 70 may be connected in series, the waveforms from each respective inductor 70 may be additive, thus yielding a single output AC waveform substantially equal to the sum of the waveforms from each inductor 70. It should be appreciated that the axial and/or radial displacements of rotor 36 and/or rotatable member 29 may serve to keep magnets 46 aligned with inductors 70, despite any shock and vibration-induced movement of the components of mobile machine 10.

The output AC waveform may then be passed as an AC source input to power regulation circuit 74 to be rectified, filtered, and regulated as power input to sensor 56 and wireless transmitting circuit 58. More specifically, the AC waveform may be rectified to a DC signal by rectifier 76. This DC signal may embody a positive DC voltage waveform substantially equal to the absolute value of the AC waveform. The DC signal may then be filtered (e.g. smoothed) to a substantially steady DC voltage by filter 78, and further regulated to a predetermined voltage by regulator 80. In other words, if the DC signal output by filter 78 has a DC voltage that is greater than the predetermined voltage, regulator 80 may limit the DC voltage to the predetermined voltage. For example, regulator 80 may limit the voltage to 7.5V DC. This 7.5V DC signal may then be passed as power input to sensor 56 and wireless transmitting circuit 58. If excess power is delivered to wireless transmitting circuit 58 (i.e. more power is delivered to wireless transmitting circuit 58 than is necessary for wireless transmitting circuit 58 to function adequately), the excess power may be stored by energy storage circuitry 82.

Sensor 56 may then generate a signal that may be used to determine a speed of traction device 14 and output this signal to wireless transmitting circuit 58. For example, as magnetic ring rotates, the second magnetic field created by poles 52 may fluctuate as observed from sensor 56, and sensor 56 may generate a DC signal indicative of the fluctuations. That is, as poles 52 of alternating polarities rotate past sensor 56, the magnetic field at sensor may correspondingly alternate polarities. Sensor 56 may output a signal periodically alternating between a low DC voltage and a high DC voltage with a period substantially equal to the amount of time it takes for two consecutive poles 52 to rotate past sensor 56. For example, the signal may alternate between 0V DC and 3V DC.

The signal generated by sensor 56 may then be passed to controller 84 for processing. For example, each time controller 84 observes a change in the signal generated by sensor 56 from the low DC voltage to the high DC voltage, controller 84 may read the value of the fixed-frequency counter and reset the fixed-frequency counter. Controller 84 may then apply the formula stored in its memory to the read value, the signal generated by sensor, the known gear ratio, and the known conversion between the rotation speed of sprocket 16 and the speed of traction device 14 to calculate the speed of traction device 14. The calculated speed may then be delivered to radio antenna 86 for transmission.

Controller 84 may deliver information regarding a power status of wireless transmitting circuit to radio antenna 86. That is, controller 84 may check whether wireless transmitting circuit is being powered by energy storage circuitry 82, and, if so, check the remaining charge of energy storage circuitry 82. Controller 84 may deliver this data to radio antenna 86 together with the calculated speed. It is contemplated, however, that controller 84 may alternatively deliver the power status information independently of the calculated speed. That is, controller 84 may deliver the power status information periodically, or only when controller 84 has observed that wireless transmitting circuit is being powered by energy storage circuitry 82. It should be appreciated that, if controller 84 sends the power status information independently of the calculated speed, controller 84 may periodically query energy storage circuitry 82 to determine whether wireless transmitting circuit 58 is being powered by energy storage circuitry 82.

As radio antenna 86 receives information from controller 84, radio antenna 86 may transmit the information wirelessly to the receiving system of mobile machine 10. The wireless information may be transmitted through dielectric outer shell 60. One skilled in the art will appreciate that, because dielectric outer shell 60 may be fabricated of a dielectric material, it may allow the wireless information to pass through with minimal signal attenuation.

The disclosed wireless rotational speed sensing device may provide a self-powered wireless signal indicative of a speed of a traction device with maximized speed resolution. More specifically, because the speed of the traction device may be calculated based on a moving part that rotates more than once per rotation of the sprocket (i.e. relative to the sensor), the sensor may be sensitive to relatively small changes in the speed of the traction device. For example, assume that the magnetic ring includes 11 pole changes per a single revolution of the magnetic ring assembly, and that one revolution of the sprocket corresponds to a traveled distance of 5 meters. Also assume that the magnetic ring rotates 22 times for each revolution of the sprocket. While the resolution of the speed signal may be 1/11^{th} of a revolution of the magnetic ring, this resolution corresponds to 1/242^{nd} of a revolution of the sprocket (i.e. 5/242^{nd} of a meter). It should be appreciated that if the sprocket and magnetic ring are driven to rotate in the same direction, the maximized resolution may be realized when the magnetic ring rotates at least twice for each revolution of the sprocket.

The disclosed wireless rotational speed sensing device may also minimize manufacturing, assembly, and repair costs. That is, the disclosed device may be manufactured with a minimum number of individual parts. More specifically, the disclosed device may be manufactured as a first unit consisting of the rotatable shaft, rotor, and magnetic ring, and a second unit consisting of the housing with the wireless rotational speed sensing unit installed therein. These parts may be applied to a variety of vehicles without modifying their size and shape configurations, thus minimizing manufacturing costs. Further, because the first unit need only be attached to an existing axle of a machine and the second unit need only be affixed to an outer, accessible, final drive housing, installation and repair costs may be minimized.

Further, because the disclosed device may not require a stator (i.e. a non-rotating member), it may be applicable to a great variety of mobile machines and traction devices. That is, the disclosed device may be used with final drive systems that do not include easily-accessible non-moving parts.

It will be apparent to those skilled in the art that various modifications and variations can be made to the disclosed device. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A speed sensing device for use with a traction device, the speed sensing device comprising:
a rotor having a first rotational speed, wherein the rotor includes magnets affixed thereon to generate a magnetic field;
a power-harvesting circuit coupled with the rotor to convert fluctuations in the magnetic field into electrical energy;
a sensor having a second rotational speed different from the first rotational speed, wherein the sensor is powered by the power-harvesting circuit to generate a signal indicative of a speed of the traction device; and
a transmitting circuit connected with the speed sensor and powered by the power-harvesting circuit to wirelessly transmit the generated signal.

2. The speed sensing device of claim 1, wherein:
a rotational direction of the rotor is the same as a rotational direction of the sensor; and
a magnitude of the speed of the rotor is at least twice a magnitude of the speed of the sensor.

3. The speed sensing device of claim 1, further including a rechargeable power-storage device connected to the power-harvesting circuit and to at least one of the sensor and the transmitting circuit.

4. The speed sensing device of claim 3, wherein the transmitting circuit further transmits data indicative of which of the power-harvesting circuit and the rechargeable power storage device is currently powering the sensor.

5. The speed sensing device of claim 1, further including a controller powered by the power-harvesting circuit to process the signal generated by the sensor.

6. The speed sensing device of claim 1, wherein the magnets affixed on the rotor are arranged with magnetic poles alternating in a circumferential direction.

7. The speed sensing device of claim 6, wherein the power-harvesting circuit includes a plurality of wire windings serially connected and having axial magnetic cores circumferentially aligned.

8. The speed sensing device of claim 1, wherein:
the magnetic field is a first magnetic field;
the speed sensing device further includes a magnetic ring rotating with the rotor, and having magnetic poles alternating in a circumferential direction to generate a second magnetic field; and
the signal generated by the sensor is based on fluctuations in the second magnetic field.

9. The speed sensing device of claim 1, wherein the signal generated by the sensor is based on the fluctuations in the magnetic field.

10. The speed sensing device of claim 1, wherein:
the sensor is a virtual sensor; and
the signal generated by the sensor is the electrical energy produced by the power-harvesting circuit.

11. The speed sensing device of claim 1, wherein the rotor is affixed to a rotatable member capable of at least one of axial and radial displacement.

12. The speed sensing device of claim 1, further including a ferrous metal ring affixed to the power-harvesting circuit.

13. A method of sensing a ground speed, comprising:
rotating a traction device at a first speed;
rotating a rotor at a second speed different from the first speed to generate a magnetic field;
converting fluctuations in the magnetic field into electrical power;
generating a signal indicative of the first speed; and
transmitting the generated signal.

14. The method of claim 13, further including storing at least a portion of the converted electrical power.

15. The method of claim 13, further including converting at least one of a frequency and a period of the signal to a magnitude of the first speed.

16. The method of claim 13, wherein:
the magnetic field is a first magnetic field;
the method further includes generating a second magnetic field; and
the signal is generated based on fluctuations in the second magnetic field.

17. The method of claim 13, wherein the signal is generated based on fluctuations in the magnetic field.

18. The method of claim 13, further including reducing a reluctance of the magnetic field.

19. A speed sensing device for use with a traction device, the speed sensing device comprising:
a rotor having a speed different from a speed of the traction device, wherein:
the speed of the rotor is related to the first speed by a known factor; and
the rotor includes magnets affixed thereon to generate a magnetic field;
a power-harvesting circuit coupled with the rotor to convert fluctuations in the magnetic field into electrical energy;
a sensor powered by the power-harvesting circuit to generate a signal indicative of the speed of the traction device; and
a transmitting circuit connected with the speed sensor and powered by the power-harvesting circuit to wirelessly transmit the generated signal.

20. The speed sensing device of claim 19, wherein the sensor rotates at the speed of the traction device.
